(19) United States
(12) Patent Application Publication
(10) Pub. No.: US 2025/0121468 A1
(43) Pub. Date: Apr. 17, 2025

(54) LINEARLY-ACTUATED CONVEYOR BELT LOADING SYSTEM FOR CNC MACHINES

(71) Applicant: Michael Gimbel, Alhambra, CA (US)

(72) Inventor: Michael Gimbel, Alhambra, CA (US)

(21) Appl. No.: 18/912,611

(22) Filed: Oct. 11, 2024

Related U.S. Application Data
(60) Provisional application No. 63/589,603, filed on Oct. 11, 2023.

(51) Int. Cl. B23Q 7/03

(52) U.S. Cl. CPC B23Q 7/03

(57) ABSTRACT

The present invention provides a conveyor system for feeding stock into a CNC machine, comprising a conveyor belt; one or more of a pneumatic, hydraulic, or electric actuator for the conveyor belt; an extendable and retractable platform, and one or more of a pneumatic, hydraulic, or electric actuator for the extendable and retractable platform, wherein the conveyor belt is mounted on the extendable and retractable platform; and wherein the platform is configured to extend into and retract from the interior of the CNC machine.

### BACKGROUND

Computer Numerical Control (CNC) machines are utilized in many modern manufacturing processes. Most CNC machines have a computer controller that reads software instructions for driving a powered mechanical robotic device that is used to process components, usually by the selective removal of material. In a CNC machine designed for milling or cutting operations, it is common practice for operators to use their hands to load and unload material (known as “stock”) into and out of a clamping device affixed to the machine table. “Stock” is typically the material blank that the CNC machine will cut down to final size and shape.

Therefore, during operation of CNC machines, manual regular loading and unloading of stock to be processed may be required. A variety of methodologies have been applied in order to supplant operators manually loading and unloading this kind of machinery. For example, a gripper for loading and unloading material into and out of a clamping device can be attached to a spindle and operated automatically to grip parts from a tray placed flat inside a CNC machine housing according to work coordinate systems in coordination with software control commands.

In a five-axis CNC machine, the cutting tool moves across the X, Y and Z linear axes as well as rotates on the A and B axes to approach the workpiece from any direction. A gripper operating in such a machine cannot easily utilize a tray placed flat inside a CNC machine housing because the platform rotates in multiple axes, which would result in the stock pieces within the traying falling out when the machine's platter tilts. On a three-axis CNC Milling Machine, a tray can be utilized inside the machine, but that tray must occupy table space that would otherwise be allocated to more workholding for more parts to be machined. Moreover, chips, coolant, and other contaminants can get on the stock or in the tray during automated stock loading and unloading, which could result in failed loading or unloading cycles.

Thus, an alternative solution which allows for supplanting operators manually loading and unloading stock with this kind of machinery is desirable. Ideally, a simple device could both deliver parts to the machine while keeping unprocessed stock and final parts outside of the CNC machine during the machining cycle.

### SUMMARY OF INVENTION

The present invention provides a linearly-actuated conveyor belt system for operation in tandem with a CNC Milling machine.

An aspect of the present invention is a conveyor system, comprising: a conveyor belt; and an extensible and retractable platform, wherein the conveyor belt is positioned on the extensible and retractable platform; and the platform is extends into and retracts from the interior of the CNC machine. In most embodiments, the conveyor has a row of material stock to be processed, and this stock is brought within the machine's travels by the conveyor such that a gripping, grabbing, or other manipulation device mounted to the spindle or the spindle head can manipulate the components. In most embodiments, an actuated door is present to guard the outside of the machine and the conveyor system from contaminants.

### BRIEF DESCRIPTION OF THE DRAWINGS

FIG. 1 illustrates a closed view of a conveyor system according to an embodiment of the present invention;

FIG. 2 illustrates a front view of a conveyor system with a platform in an extended position according to an embodiment of the present invention;

FIG. 3 illustrates a back view of a conveyor system with the platform in an extended position according to an embodiment of the present invention; and

FIG. 4 illustrates a conveyor system with the platform extended into a five-axis CNC machine.

### DETAILED DESCRIPTION

The present invention allows for automated loading and unloading of stock with a spindle gripper, vacuum grabber, or other spindle-mounted or spindle-head-mounted device in a CNC machine. Many automatic part-loading systems for CNC Milling machines are complex and costly. For instance, a typical approach to loading an unloading a basic CNC machine involves integrating an independent six-axis robot with the CNC Machine Tool. Since these systems are incredibly expensive and difficult to program, the present invention provides a mechanically simple method for a CNC Milling machine to receive parts for loading and unloading. While current CNC Loading Solutions use external robotics or actuators to load the components in the CNC Machine's workholding, the present invention instead only provides the machine a consistent feed of parts, allowing the machine to load itself with the aid of a CNC Spindle Gripper, CNC Vacuum Grabbing System, or other manipulation apparatus. The present invention provides a feed for the CNC Machine to load and unload itself with the aid of a CNC Spindle Gripper or other machine-mounted apparatus that can grab and release stock. Since a five-axis CNC Machine typically has a moving head that can traverse in the X, Y, and Z axes in the cartesian coordinates system, the machine can be programmed to grab and release stock or finished parts anywhere within the machine's linear travels. In a three-axis CNC machine, it is possible to use a tray in combination with a CNC Spindle Gripper; however, the present invention can provide a consistent feed of stock material to the machine while allowing the entirety of the three-axis CNC Machine's table to be used for fixturing or workholding of components for processing. In most embodiments the present invention designed to work with three-axis CNC Machines, and the linear actuation of the conveyor is powered by a servo or stepper motor to allow the precise positioning of the raw part under the spindle head.

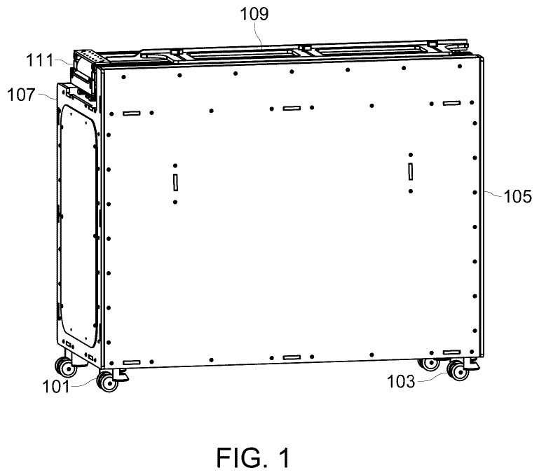

FIG. 1 illustrates a closed view of a conveyor system according to an embodiment of the present invention.

Conveyor machine body 105 houses either a pneumatic, hydraulic, or electric actuator that extends and retracts the extendable platform 109. Retractable and extendable platform 109 is positioned on deck 107. Conveyor belt 111 is positioned on retractable and extendable platform 109. Conveyor belt 111 has its own motor in most embodiments. Front wheels 101 and back wheels 103 allow for the conveyor machine to be easily positioned adjacent to a CNC machine, and can include brakes for locking the conveyor system into position once operation is ready to commence. In some embodiments, the apparatus is instead bolted to the floor. In some other embodiments, a quick-release positioning system is used to enable the apparatus to be easily moved between different machines.

The conveyor belt can extend or contract in a variety of different manners. Several ways to extend or contract the conveyor belt are with a motor and lead-screw or timing belt, or with a pneumatic or hydraulic actuator. Other variations are possible, however. Most embodiment are designed to operate with three-axis CNC machines, and a servo or stepper motor in conjunction with a lead-screw or timing belt is used because electrical control allows perfect centering of a stock component underneath the fixed column of the CNC machine. In most embodiments that require safety lockouts or similar safety equipment such as light curtains, electrical actuation of the extendable platform is used.

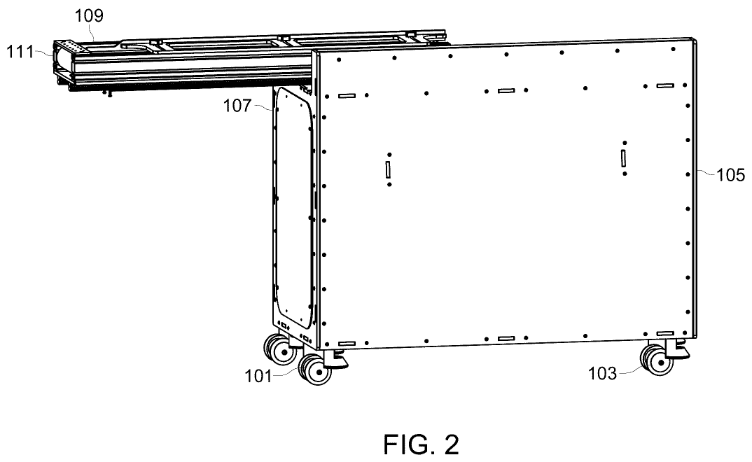

FIG. 2 illustrates a front view of a conveyor system with a platform in an extended position according to an embodiment of the present invention.

The motor housed within conveyor machine body 105 is activated to extend retractable and extendable platform 109. Retractable and extendable platform 109 is now positioned partially on deck 107 on the top of conveyor machine body 105 and partially extended off conveyor machine body 105. Conveyor belt 111 is positioned on retractable and extendable platform 109 and can be in continuous operation by its own motor. Front wheels 101 and back wheels 103 may be locked by brakes during this operation.

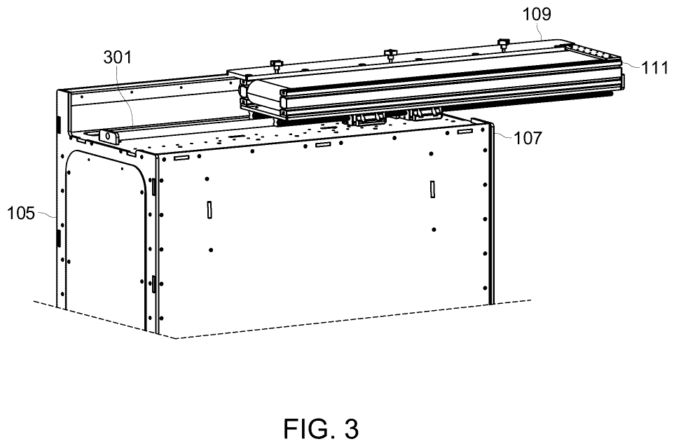

FIG. 3 illustrates a back view of a conveyor system with the platform in an extended position according to an embodiment of the present invention.

In this view, track 301 is visible and provides a track for retractable and extendable platform 109. The motor housed within conveyor machine body 105 is also activated in this view to extend retractable and extendable platform 109. Retractable and extendable platform 109 is now positioned approximately partially on deck 107 above conveyor machine body 105 and partially extended off conveyor machine body 105. Conveyor belt 111 is positioned on retractable and extendable platform 109 and can be in continuous operation by its own motor. Front wheels 101 and back wheels 103 may be locked by brakes during this operation.

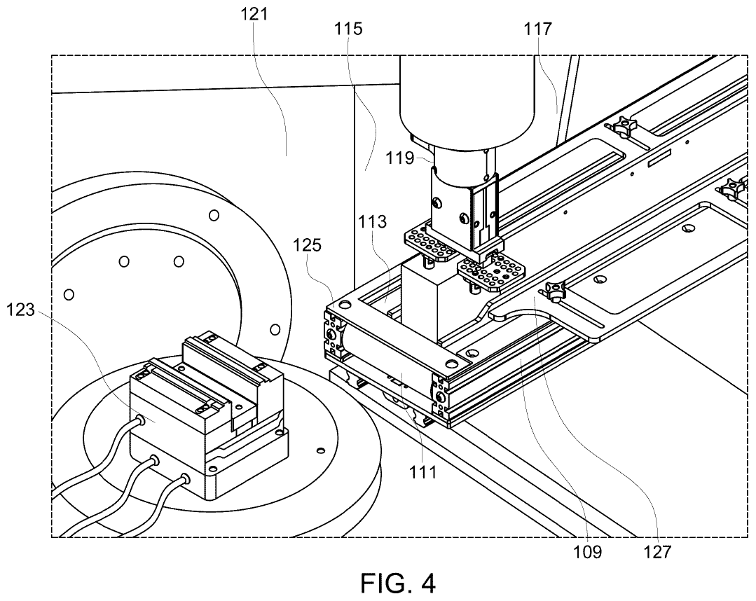

FIG. 4 illustrates a conveyor system with the platform extended into a five-axis CNC machine.

CNC machine spindle gripper 115 retrieves stock from conveyor belt 111. CNC machine spindle gripper 115 is attached to CNC machine spindle 119. Stock 113 is carried by CNC machine spindle gripper 115 to vice 123 where stock 113 will be machined. Automatic door 117 opens and closes to allow extendable and retractable platform 109 to access CNC machine housing 121. Extendable and retractable platform 109 retracts and automatic door 117 closes before machining to avoid debris and fluids being ejected out of CNC machine housing 121.

In embodiments, an external control unit can operate automatic door 117 and/or extendable and retractable platform 109. In other embodiments, external devices such as a pneumatic vise or an automatic door are controlled by the system's existing internal control. Control can be integrated with CNC machine control to tie the operation of automatic door 117 and/or extendable and retractable platform 109 to the machining cycle. Conveyor belt 111 can be controlled by the same process, or conveyor belt 111 can continue in operation with stock stacking up against stopper 125. Rails 127 can hold stock in position along the other axis of the plane of conveyor belt 111.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A conveyor system for feeding stock into a CNC machine, comprising:
a conveyor belt;
one or more of a pneumatic, hydraulic, or electric actuator for the conveyor belt;
an extendable and retractable platform, and
one or more of a pneumatic, hydraulic, or electric actuator for the extendable and retractable platform,
wherein the conveyor belt is mounted on the extendable and retractable platform; and
wherein the platform is configured to extend into and retract from the interior of the CNC machine.

2. The system of claim 1, further comprising an actuated door on the CNC machine.

3. The system of claim 1, further comprising rails positioned on the conveyor belt.

4. The system of claim 1, further comprising a stopper at an end of the conveyor belt.

5. The system of claim 1, further comprising wheels mounted on the bottom of the body.

6. The system of claim 1, further comprising an external control unit for the conveyor belt motor.

7. The system of claim 1, further comprising an external control unit for the extensible and retractable platform.

8. The system of claim 1, further comprising an external control unit for the extensible and retractable platform.

9. The system of claim 1, further comprising an external control unit for the automatic door.

10. The system of claim 6, wherein the control unit extends and retracts the platform based on the machining cycle of the CNC machine.

11. The system of claim 8, wherein the control unit extends and retracts the platform in coordination with the control of the automatic door.

12. The system of claim 1, wherein the conveyor belt motor continues to operate throughout the extension and retraction of the platform.
